(19) United States
(12) Patent Application Publication
(10) Pub. No.: US 2010/0113092 A1
(43) Pub. Date: May 6, 2010

(54) ACCELERATOR DEVICE FOR ATTACHING TO A PORTABLE ELECTRONIC DEVICE

(75) Inventor: Sean Mitchell, Dublin (IE)

Correspondence Address: CHOATE, HALL & STEWART LLP, TWO INTERNATIONAL PLACE, BOSTON, MA, 02110, US

(73) Assignee: Linear Algebra Technologies Limited, Dublin (IE)

(21) Appl. No.: 12/523,637

(22) PCT Filed: Jan. 17, 2008
(86) PCT No.: PCT/EP2008/050530

§ 371 Date: Jul. 17, 2009

Related U.S. Application Data
(60) Provisional application No. 60/885,263, filed on Jan. 17, 2007.

(30) Foreign Application Priority Data
Jan. 17, 2007 (GB) 0700877.4

(51) Int. Cl. H04M 1/00

(52) U.S. Cl. 455/556.1

(57) ABSTRACT

The present application provides an accelerator device for attaching to a portable electronics device. The portable electronics device communicates using a serial or similar interface with a corresponding interface of the accelerator device. Raw data is transmitted from the portable electronics device for processing by the accelerator device. The accelerator device contains a processor for processing the communicated raw data into processed data and returns the processed data to the portable electronics device. This arrangement allows the processor of the accelerator device to assist the applications processor on the portable electronics device in the processing of data by splitting the processing between the processor of the accelerator device and the portable electronics device.

### FIELD

The present application relates to portable electronic devices.

### BACKGROUND OF THE INVENTION

Personal Computers (PCs) can run many types of multimedia and computational applications, including games, through software on their powerful processors. With the increasing popularity of mobile devices (e.g. wireless phones), it is desirable for users to be able to run many of these types of applications also on mobile devices. However, the processors in mobile devices are not as powerful as those in PCs, for reasons including for example constraints of cost, size and power consumption. As a result, it's either not possible to run many of these applications on mobile devices or else they won't run with the same levels of performance as they do on PCs.

Whilst the processing power of the wireless devices could be increased, there is going to be associated increases in cost and in size. Whilst, it is inevitable if Moore's law continues apace, that the processing power provided in mobile devices will improve and costs and size reduce, the situation in the meantime is that the more sophisticated applications including for example complex computer games will be excluded from operation on mobile devices.

It is known to have modules that connect to portable electronic devices. For example, US2006/0023429 discloses a plug-in module to allow a portable electronic device to function as a vehicle diagnostic system by providing an interface to the various sensors required to conduct testing. Similarly, US2004/0260410 provides card modules which may be plugged into a Portable Digital Assistant (PDA) to increase the functionality of the PDA, in these modules the additional functionality is performed solely within the modules. The module runs a program which performs the full functionality of the desired module, e.g. audio player, navigation program, game etc. The PDA is only used to present the output of the modules on the display or speaker of the PDA thus the data flowing between the PDA and the modules are limited to control information.

The present application provides a solution to this and other problems.

### SUMMARY OF THE INVENTION

Accordingly, a first embodiment of the invention provides a system with a portable electronics device and an accelerator device. The portable electronics device comprises a display, a keypad or other device for accepting inputs from a user, at least one applications processor, at least one memory, the applications processor and memory being configured to run software on the portable electronics device, an interface for transmitting and receiving data from the applications processor and the interface having an associated socket. The accelerator device comprises a connector for engaging with the associated socket, an interface associated with the connector for communicating with the interface of the portable electronics device and transferring data communicated between the portable electronics device and the accelerator device via the connector and socket, a processor for processing the communicated data into processed data and being configured to return the processed data to the portable electronics device, wherein the processor of the accelerator device assists the applications processor on the portable electronics device in the processing of data. The interface between the accelerator device and the portable electronics device is a digital interface, optionally a serial interface. The interface may be a USB interface, a memory interface or a cartridge interface. Generally, the accelerator device is provided as a dongle. The dongle comprises a housing, the housing having a connector provided thereon for co-operating with a compatible connector on the portable electronics device. The at least one accelerator device processor is suitably provided as a integrated circuit die or packaged integrated circuit mounted on a printed circuit board and contained within the housing. The dongle may comprise a clock source. Similarly, the dongle may have a power source, suitably rechargeable. At least one memory device may be provided within the dongle. The dongle housing is suitably in a form for matching with the socket of the portable electronics device. For example, the dongle housing may be provided in the form factor of a memory card, a USB Key, or a cartridge.

Suitably, the system is adapted to operate a layered software application, wherein at least one higher layer of the software is performable on the portable electronics device and where at least one lower layer of the software is performable on the accelerator device.

The division between layers operating on the portable electronic device and the accelerator device may be selected to minimise data transfer between the two devices and\or to minimise linear algebra calculations on the portable electronics device.

Preferably, the accelerator device processor is particularly suited to algebraic calculations. The accelerator device processor and the applications processor may be different types of processor.

In a further embodiment, a method of operating a system is provided, the system comprising a portable electronics device having at least one processor and an acceleration device having at least one processor, the acceleration device being configured to assist the portable electronics device in the processing of data. The method comprises the steps of;

a) determining the presence of the acceleration device,

b) transmitting data to the acceleration device for processing,

c) receiving processed data from the acceleration device.

The step of determining the presence of the acceleration device may comprise the step of identifying the acceleration device, in which case a further step may be provided comprising the step of downloading program code to the acceleration device in response to the identification of the acceleration device. The method may comprise the step of initially downloading general information about subsequent data to be processed. Suitably, the time for transmission and reception of data is relatively short compared to the time required for the transmitted data to be processed by the processor of the portable electronic device.

In another embodiment, a portable electronics system is provided comprising: a mobile device and a dongle separable from but operably coupled to the mobile device, wherein the dongle enables, accelerates or improves the execution of certain applications running on the mobile device.

Suitably, the mobile device and dongle are operably coupled via a digital interface. The digital interface may be a USB interface, a memory card interface or a cartridge interface. Similarly, the digital interface may be a proprietary expansion interface. The mobile device may be a radio\wireless telephone or a portable gaming console.

The dongle may comprise at least the following components: a housing, a connector compatibly formed for mating with a compatible connector on the mobile device, and at least one integrated circuit die or packaged integrated circuit mounted on a printed circuit board and contained within the housing.

The dongle may also include a clock source, a power source and/or one or more memory integrated circuits. The housing may be in the form factor of a memory card, a USB Key or a cartridge.

Advantageously, the application may involve at least one of the following; physics processing, artificial intelligence processing, linear algebra, geometric algebra processing, image processing, image recognition, graphics processing, and\or a search engine.

In yet another embodiment, a method is provided for enabling, accelerating or improving the running of certain applications on a mobile device comprising at least the steps of: detecting when a dongle is operably coupled to the mobile device, and using processing resources within the dongle to enable, accelerate or improve the running of certain applications on the mobile device. The method may further comprise the step of displaying a warning message to the user in the event that a dongle is not detected and\or defaulting to an alternative mode of operation in the event that a dongle is not detected.

In a further embodiment still, an accelerator device is provided for attaching to a portable electronics device having an interface. The accelerator device comprises an interface for connecting to the interface of the portable electronics device and for accepting raw data for processing communicated from portable electronics device, a processor for processing the communicated raw data into processed data and being configured to return the processed data to the portable electronics device, wherein the processor of the accelerator device assists the applications processor on the portable electronics device in the processing of data.

The advantages of these and other embodiments will become apparent from the detailed description which follows.

### BRIEF DESCRIPTION OF THE DRAWINGS

The present application will now be described with reference to the accompanying drawings in which:

FIG. 1 is an exemplary schematic of a wireless device suitable for use in the present invention;

FIG. 2 illustrates an exemplary arrangement according to the present invention;

FIG. 3 is an exemplary schematic of an accelerator device according to the present invention;

FIG. 4 is an illustration of a layered approach suitable for division of processing workload in accordance with the present invention;

FIG. 5 illustrates different types of exemplary object interactions in games physics which may be modelled and processed using the present invention;

FIG. 6 illustrates process flows in calculations which may be implemented in the present invention;

FIG. 7 is a representation of how the process flows of FIG. 6 apply to the models of FIG. 5;

FIG. 8 is a representation of how the significant calculation workload for calculating data on an object may be allocated to the device of FIG. 3 without significant data transfer; and

FIG. 9 is an exemplary flowchart according to the present invention.

### DETAILED DESCRIPTION OF THE DRAWINGS

The present application provides an improvement to the current situation whereby portable electronic devices cannot run computationally complex software applications in a timely manner.

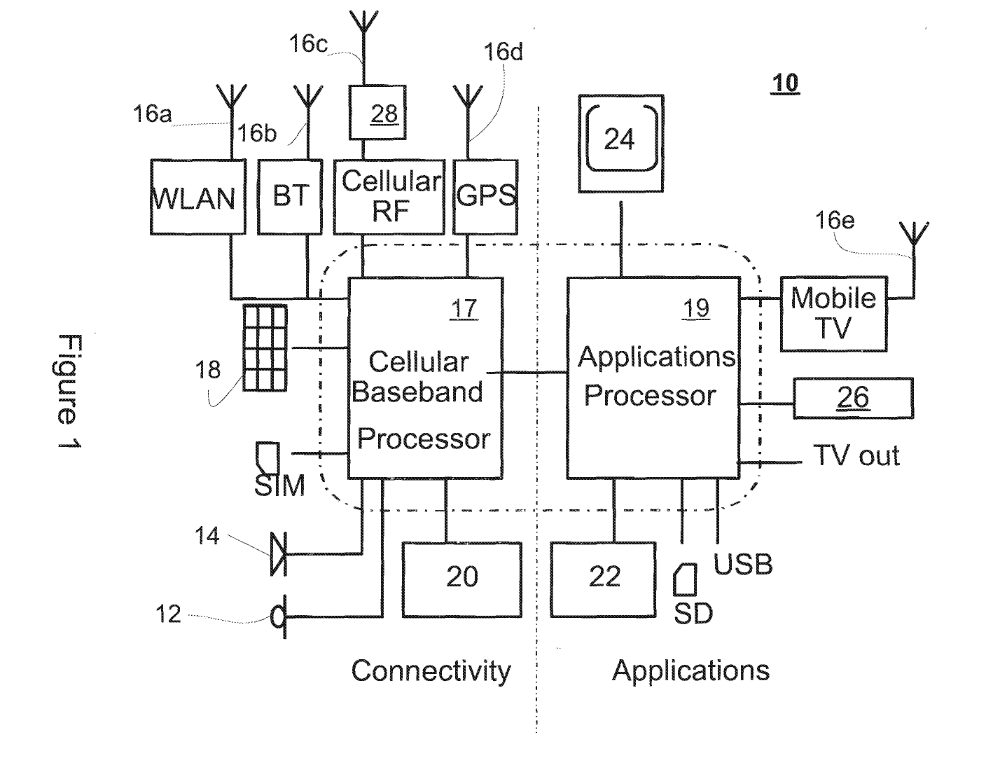

Conventionally, as shown in FIG. 1, the elements of portable electronic devices 10, including for example mobile telephones, are separable at least conceptually in accordance with two separate functions; connectivity and applications. Although, depending on the particular design of portable electronic device the division and distinction between the two functions may not be clear, e.g. where the portable electronic device employs a single processor to perform all functions.

The connectivity function relates to how the portable electronic device communicates with the outside world. The connectivity part of the portable electronic device typically comprises a processor 17 for processing the incoming and outgoing data (including audio data representing incoming and outgoing speech and other data including messages, pictures etc.). The outgoing data may be obtained from the device's microphone 12, a SIM card present in the device, keypad 18, or from the application function of the device. The processor 17 converts this outgoing data into a form suitable for transmission and passes the converted data to transmission circuitry for modulation and subsequent transmission via an appropriate antenna 16a-16e. A separate power amplifier 28 may be provided as necessary to provide a transmitted signal. There are a variety of known arrangements for wireless transmission including GSM, CDMA, WiFi and Bluetooth. Multi band devices are capable of broadcasting on different bands to facilitate users when roaming between countries using different standards. Similarly multi-mode phones are known which are capable of switching modes, for example from CDMA to GSM, as required. More recently, multi-mode phones have been introduced which determine the presence of a WiFi connection and where one is present allow telephone calls to be conducted as VoIP calls rather than as a conventional wireless call.

An associated memory 20 may be provided externally to the processor. Incoming data is demodulated and passed to the processor for processing including for example the outputting of received speech through a loudspeaker 14 or earphone. Similarly, received non-speech data may be provided to the applications part for subsequent processing\display to the user on the device display 24.

The application function is directed to the functions not directly associated with wireless communication, including for example the displaying of received messages, issuing reminders, address books, e-mail, word processing, displaying or taking of pictures and video, playing games etc. Typically, the Applications Processor 19 in most wireless devices is based around a 32-bit fixed point ARM processor. A recently introduced application is mobile television for wireless devices. In the exemplary schema shown in FIG. 1, this is represented on the applications side, although conceivably it may also be partially positioned in the connectivity side. Similarly, whilst reception of GPS data may be represented on the connectivity side, an application employing the GPS data may be provided on the applications side. The applications side is typically also responsible for communication with attached devices including cameras 26, USB connections (e.g. to an external computer and removable memory e.g. a SD card). The applications processor may have external memory 22 in addition to on-chip memory. Notwithstanding that the connectivity functionality may be separated from and controlled by a separate processor to the applications functionality, existing portable electronic devices do not have the required processing power to perform complicated calculations in a sufficiently short time period to allow certain functionality, including the playing of complex games.

The present application provides a means of increasing the processing capability of a portable electronic device in order that it becomes capable of running more sophisticated applications. To achieve this, the present application provides additional processing circuitry, for example provided as a dongle, which is connected by a digital interface to the mobile device. The overall task of running the complex application is then split between the applications processor and the additional processing circuitry. In this way, there is no required change to the hardware design of the mobile device as the additional processing circuitry may be provided as a distinct element to the existing hardware, for example as an externally attachable device (a dongle). Nonetheless, the processing capability of the portable electronic device is increased and the device becomes capable of running new applications that were not previously possible or existing applications may be accelerated. The arrangement provides for a complex application to be processed in a layered fashion with the primary processing (higher layers) performed by the processor of the portable electronic device. Specific elements which are computationally complex are offloaded in a lower layer for processing by the processor of the dongle. Suitably, the processor of the accelerator device is configured to perform these complex computations at speeds at least five times faster than the on-board processor of the portable electronics device. Preferably, the speed is at least ten times faster. In particular, the processor of the dongle may be configured to efficiently perform matrix calculations which may be computationally expensive in conventional ARM processors as employed in mobile devices.

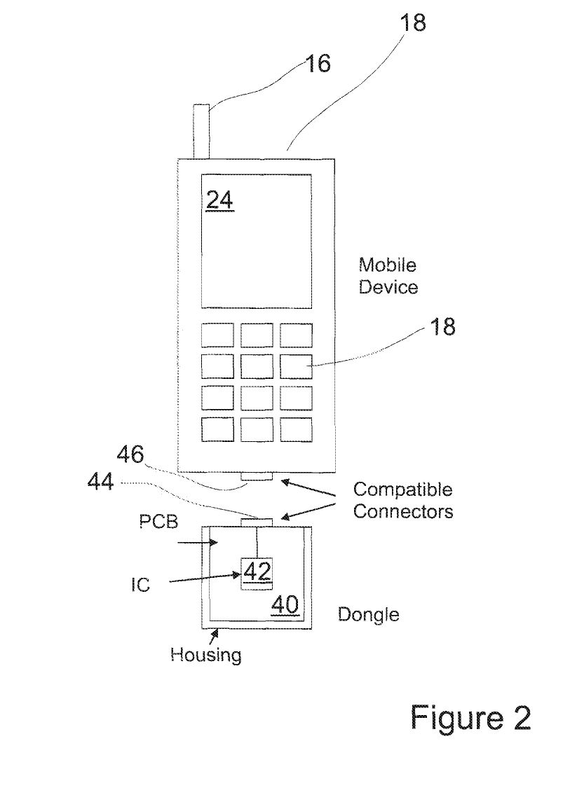

In particular, the present application provides an accelerator device 40, as shown in FIG. 2, for interfacing to a portable electronic device 18. The accelerator device is arranged so that the processor on the accelerator device may be employed to accelerate or improve the performance of applications operable on the mobile device. Advantageously, as will be discussed below the additional processing circuitry may be particularly suited to linear algebra processing.

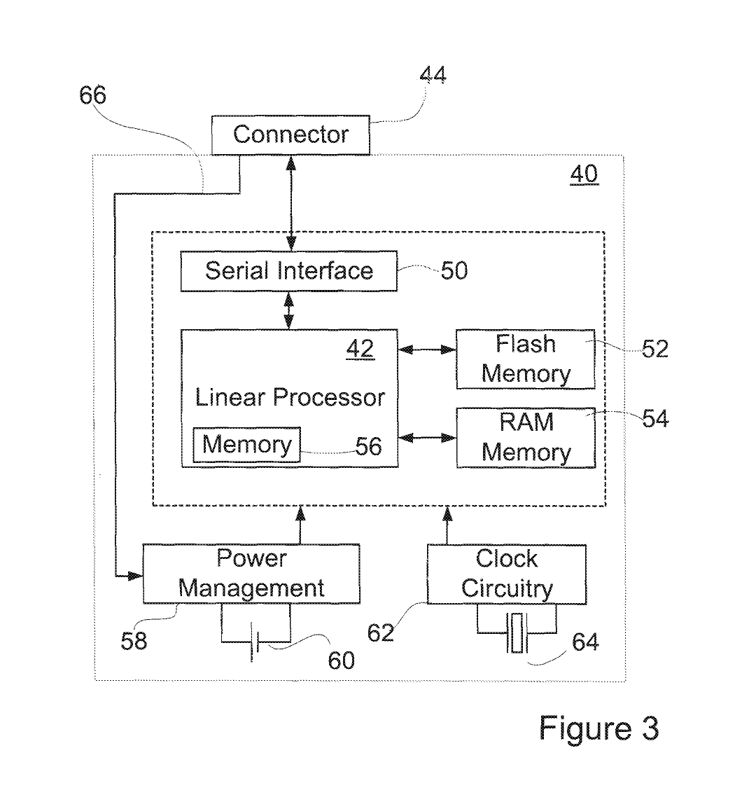

The accelerator device 40, as further shown in FIG. 3, comprises a connector 44 for physically connecting to an equivalent connector 46, e.g. USB or mini-USB, on the mobile device. The connector connects a digital interface 50 of the accelerator device to a corresponding digital interface on the wireless device. Suitably, the digital interface is a Universal Serial Bus (USB) interface, or a flash memory interface, e.g. a Secure Digital Input/Output (SDIO) interface as used for multimedia cards (MMC). An advantage of employing the SDIO interface is that the accelerator device may be constructed in the form of a MMC card for insertion within the MMC space of suitable mobile devices. Where an MMC slot is provided in the side of a phone for receiving a MMC card, the accelerator device may have a longer footprint than in the case where the card is received within an internal socket of the mobile device.

Other methods of connection may be employed between the wireless device and the accelerator device, including for example wireless communication, e.g. BLUETOOTH, although the effective data transfer speed to the applications processor of the wireless device could limit the effectiveness of the accelerator device in this configuration. Similarly, where available, the mode of connection may be by means of a cartridge interface or a proprietary expansion interface on the mobile device.

Data, as will be discussed below, is transferred between the accelerator device and the portable electronic device over the digital (typically serial) interface. In addition, power for the accelerator device may be drawn 66 from the serial connection of the mobile device. Alternatively, or as a back-up, a battery 60 may be provided on the accelerator device. Power management circuitry 58, e.g. regulation, filtering, conversion and/or protection, may be provided on-board the accelerator device.

The accelerator device may have more than one processor 42 to share the processing load. In the case of a multiple processor arrangement, there may be a general processor which is responsible for allocating separate tasks to individual linear algebra processors from a plurality of linear algebra processors, for example as the result of an island partitioning step in the games physics arena. Nonetheless, for simplicity the description of the exemplary accelerator device described herein will be limited to the case of a single processor.

Suitably, the processor has reasonable on-board memory 56 to improve overall speed and reduce caching requirements. Additional external RAM 54 may be provided. In addition, a ROM 52 (e.g. flash) memory may be provided on which boot-up code for the accelerator device is stored or for storing application code or digital media such as audio, image or video media. Employing flash memory allows for subsequent upgrading of the boot-up code to newer versions. Clock circuitry 62 employing, for example, a crystal 64, provides a clock signal on the accelerator device or, alternatively, a clock signal could be provided to the accelerator device from the mobile device.

The circuitry of the accelerator device may, for example, be provided as a plurality of discrete components mounted on a printed circuit board or as some other form of electronics module (for example, an LTCC module). Where space is at a premium, e.g. in a MMC card format, the processor could be a bare die mounted onto the PCB using Chip Scale Packaging (CSP) or flip-chip technology.

As with other devices which might be connected to the digital interface, the mobile device may be capable of detecting the presence of the accelerator device and performing certain initial routines including identifying the type of device, authenticating it and selecting appropriate drivers etc. Techniques for achieving this are well known in the art.

The accelerator device may be used to enable, accelerate or enhance the running of many types of applications, particularly those for which the applications processor of the portable electronic device is not well suited such as those that require floating-point calculations or dedicated hardware structures. Examples would be applications which require physics or artificial intelligence processing, linear or geometric algebra calculations, image processing or recognition, graphics processing, or search engines.

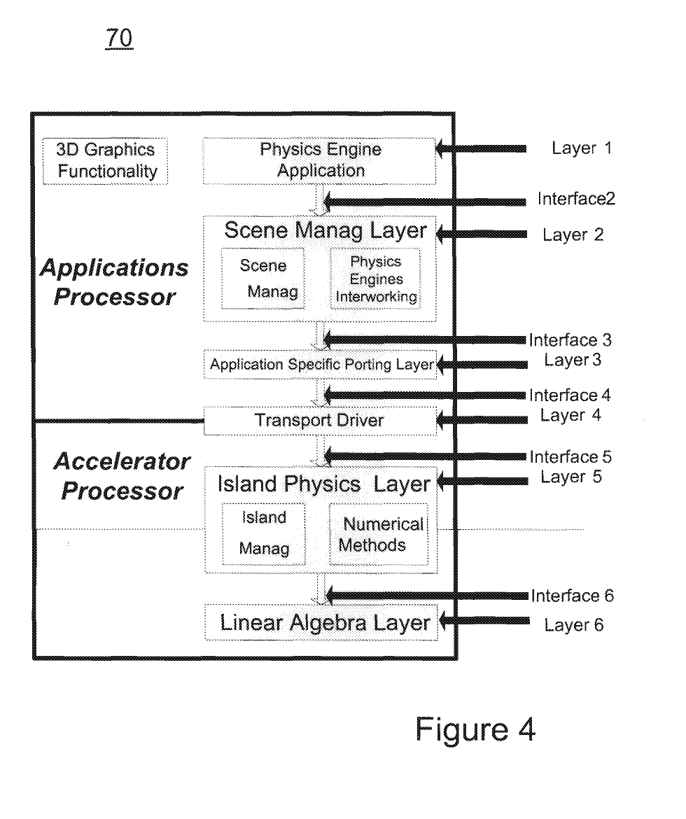

In particular, the accelerator device may be employed to perform the functions of certain layers within a layered structure 70 of an application, for example a game application as shown in FIG. 4, in which the accelerator device is employed\configured specifically to co-operatively function with the applications processor as a physics engine. In particular, the layered structure is arranged so that the accelerator device is responsible for computationally expensive calculations which are required on a relatively small amount of data. In this arrangement, the combined speed of operation of the applications processor of the mobile device and the linear algebra processor of the accelerator device is not compromised by the bandwidth of the digital connection therebetween.

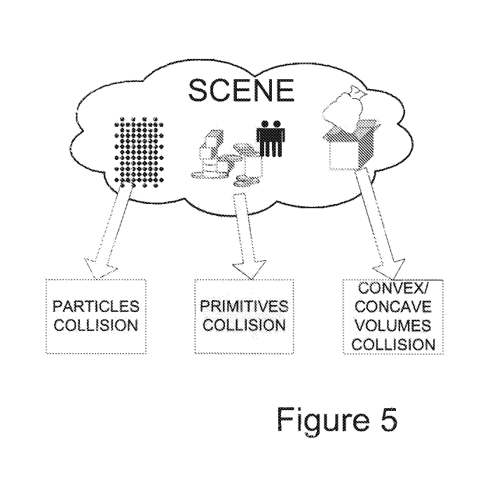

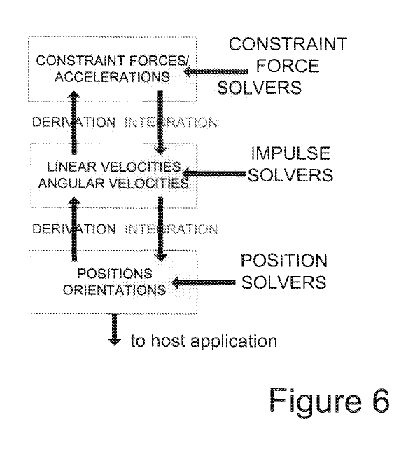

To assist in the understanding of the nature of the layers, a discussion on games physics will now be provided. Computer animation physics or game physics involves the introduction of the laws of physics into a simulation or game engine, particularly in 3D computer graphics, for the purpose of making the effects appear more real to the observer. It is generally believed that it is more important to provide a believable physics behaviour rather than an accurate one. Thus a multitude of algorithms, approaches and architectural options may be employed in game physics to provide a particular gamer experience. Nonetheless a physics engine is expected to detect when two or more objects, as shown in FIG. 5, are interacting and resolve the interaction in a physically realistic way. In order to augment the virtual reality experience with even more realistic experience the physics has to be affected by player interface, by featuring in the game intelligent non-player characters (NPC), all in a captivating game scenario produced by the game logic. A particular goal of a game physics engine is to provide at each frame (to be rendered) believable positions and orientations for all the dynamic bodies in the scene represented by the frame. In order to achieve that, a game physics engine runs a set of simulation steps within the time budget provided between two subsequent frames. Usually, in order to do that, a physics engine has to detect first of all what are the interactions that occur between the dynamic bodies. Then, based on the detected interactions, the engine has to solve them based on the Newtonian physics principles, as shown in FIG. 6. Finally, it has to update the position and orientation of the affected bodies in the scene.

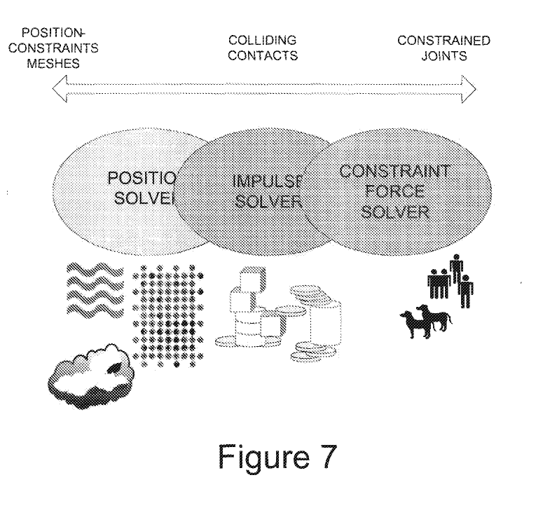

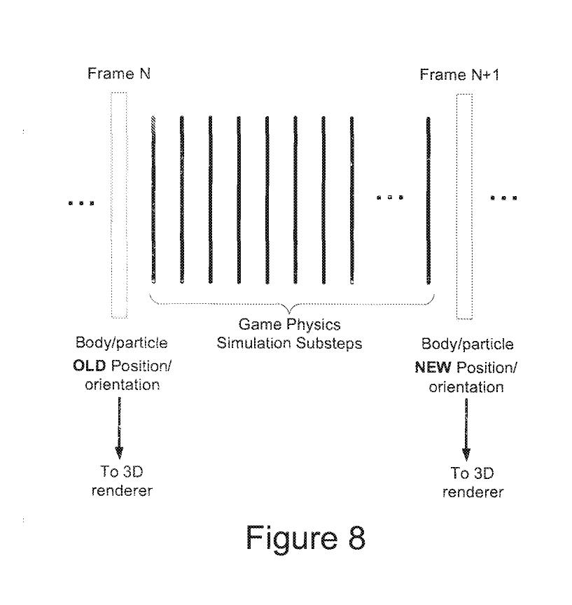

In any particular scene, a body can be engaged in more than a single interaction/collision, e.g. it can collide or have a frictional interaction with several bodies at the same time as represented by FIG. 7. Hence, one should know that most of the engines solve the interactions/collisions detected between bodies pairwise and, hence, they have to run a sequence of simulation substeps, most of the time repeating same sequences, until an equilibrium is reached between all the bodies in the scene. This may be observed in FIG. 8 where a sequence of substeps is depicted between two subsequent frames (N, N+1) that have to be rendered. Out of the simulation substeps in FIG. 8, the first one is usually a collision detection stage and the last one is a position update. The ones in between the two are usually iterations of the solver that has to solve the collision detection events and give a resolution to them. The resolution (i.e. resulting constraints forces, velocities) have to be integrated in the last substep in order to get positions and orientation updated. One should mention that the most stable and efficient physics engine employ iterative methods for the solvers, hence the several iterations/substeps in the simulation. FIG. 8 demonstrates that the iterative nature of the solver is computationally expensive. Similarly, FIG. 8 also shows that the bandwidth between a game physics engine and the rendering pipeline is relatively small as the information sent from the physics engine to the application responsible for rendering consists of data such as the new positions and orientations of the objects at each frame. This small bandwidth requirement facilitates the use of the application processor of the mobile device for graphics rendering and the use of the accelerator device processor as a physics engine.

For completeness, some elements of games physics components in a physics simulation would include; collision detection, island partitioning, solver\collision resolution and position update or integration. Collision detection is employed to solve the problem of determining when any two or more physical objects in the environment cross each other's path. Island Partitioning is employed to break the whole scene into independent islands or clusters of interacting bodies/objects. Based on this divide and conquer technique the solver is helped to manage tracktable problems rather than overwhelmingly large problems for which the solver wouldn't have the memory and processing resources. Solver or Collision Resolution is the use of algorithms to simulate and resolve interaction/collisions between the colliding or articulated objects. Position Update or Integration implements Newtonian physics within the environment based on the resolution from solver\collision resolutions.

A classic combination that is employed in physics engines is one whereby collision detection is run first at the beginning of a new frame to see whether new events occur. Then, based on the new interactions configuration the problem is divided in smaller independent sub-scenes (islands) by the partitioning algorithm. Then, the solver processes each island sequentially and finds the resulting dynamics constraints of each island. Based on these results the position update calculates the new position and orientations of the bodies in each island. The function of Collision Detection may be staged to reduce the computational workload and in particular, a Broad-phase collision detection may be first employed, which is responsible for selecting pairs of objects that are worthy of collision/intersection tests (E.g.: if objects are too far one from another it is useless to check their collision) and secondly a Narrow-phase collision detection, which determines if in fact two objects collide (intersect/penetrate) or not. In case of collision, this phase must also supply collision information that describes the collision. Such information is subsequently used during collision removal.

Returning to the layered structure of FIG. 8, some greater detail on the division of workload between the wireless device and the accelerator device will now be discussed.

The top layer Layer_{—}1 is the Game itself—i.e. the application which is using the physics engine of the accelerator device. Suitably, the physics part of the game application will be written in a suitable physics format to describe the game scene or the set of scene sub-problems that have to be physics simulated (discussed in greater detail below). To provide a maximum of abstraction and hence minimisation of the work of the applications processor, there may be no information in this layer about the choice of physics algorithms to solve the scene interactions. Suitably, this layer may also use a particular graphics engine/API such as OpenGL and possibly some game AI functionality. Advantageously, this layer may be compiled for the specific application processor, e.g. ARM11 and will most likely have minor customizations for items such as the user interface buttons available on particular mobile devices etc.

Interface_{—}2 This is the Applications Programming Interface (API) used by the applications processor when running the game to construct and manipulate the physics model of the game universe. Functions provided in the physics API in this interface allow the game to create and place primitive objects, interactions between them (e.g., joints), specify forces to be applied on objects, and also the world parameters (contact or joint damp, restitution, softness, friction etc parameters). It will be appreciated that this functionality has relatively low demands in terms of processing.

Layer_{—}2 This layer suitably models a game universe specified by the game. This involves tracking information such as the type, position, mass, velocity, and forces for each object created by the game. Periodic physics updates are requested by the game, which basically causes the engine to take the object positions/velocities/forces at t=n, and cause the recalculation of new positions/velocities/forces for t=n+1. The layer is responsible for determining the types of calculation to be carried out, which will vary depending on the particular physics problem, as would be familiar to those skilled in the art of games modelling (including for example rigids, deformable bodies, particle systems, destructive bodies etc).

One can say that this layer deals with “scene management”. This means firstly an analysis of the physics nature in the scene (objects' and interactions' type) both from previous frames information (coherence history) and information about new events detected in the current frame, secondly a partitioning of the general scene physics problem (objects in the scene) based on the type of interactions between them, and finally a splitting of the scene into independent problems to be submitted to certain combinations of numerical methods. Analysing the nature of the interactions in each independent island justifies the selection of the most suitable “numerical algorithms”.

For example, in FIG. 5 the functionality of this layer can select the appropriate set of exact/narrow collision algorithms for different types of collisions based on the geometry of the two bodies involved in the collision test. As each object in the scene is described within a data construct, the nature of collision may readily be determined. Based on the nature of the interactions detected in an island the appropriate solver has to be chosen and in case of interactions between two different types of islands/objects (drapery falling on a ragdoll).

Also some level of temporal coherence information caching should be managed in this layer to help the analysis and partitioning functionality both to warm-start and reduce the amount of interaction update computation.

Another functionality that this layer has to provide is for the cases when the linear algebra processor of the accelerator device is overwhelmed by the amount of information it has to process, that is, the scene size is a few times larger than the physics problem that the linear algebra processor has been designed to solve at each frame. In such cases the host has to manage the scene information and pass onto the accelerator device bulk memory, sequentially, the scene information batches (sets of possibly colliding bodies to be collision tested or sets of interactions to be solved by the appropriate solver) that have to be solved with the appropriate numerical methods.

A cache may also be hosted at this layer with information about the scene that is at least the geometry information to be passed onto the graphics functionality with the updated position and orientation at each frame.

Interface_{—}3 This is an interface which abstracts any processor-specific or system-specific functions required by the software on-board the accelerator device. The most important of these functions is read/write access to the accelerator device, but these functions may also include memory management, mutual exclusion, thread/process control, interrupt management, etc. The interface to access the accelerator device is suitably provided in a clean portable way to the upper layers, so that they are abstracted from the implementation details.

Layer_{—}3 This layer abstracts the Accelerator device software (firmware provided in the flash memory or downloaded from the mobile device) from the processor-specific aspects of the application processor. This generally involves interfacing with the system RTOS and/or control firmware as well as drivers for various hardware devices. The major functionality located is read/write access to/from the accelerator hardware, as well as managing interrupts. Other system-specific aspects include memory management, power management, etc. The upper layers can access the accelerator device hardware via single-word and block read/writes, and this layer must be flexible enough to efficiently abstract access whether the accelerator device hardware is memory-mapped or accessed via a serial digital interface such as SPI or SDIO. The actual lowest-level read/write operations are passed on to the transport layer below.

Interface_{—}4 This is a small interface which provides read/write access to the accelerator device hardware. This is implemented separately due to the importance of this layer during debug and test, as well as the fact that this interface is more system-specific than even the porting layers above. Since the underlying hardware interface may be able to support block or burst transfers care should be taken to make the software interface as generic as possible.

Layer_{—}4 This layer implements the actual read/write access to the accelerator device hardware. Suitably, part of it is provided on the host side and part of it on the accelerator device side. Depending on the hardware/system configuration, this layer may be a very thin set of macros to directly access memory, or may interface to lower-level system drivers such as SPI. In the latter case, this interface “interface_{—}4” is highly system specific depending on the hardware interface. This is the hardware interface between the Applications Processor and the accelerator device hardware. This physical interface between the host and the processor in the accelerator device depends on the implementation technology and configuration of the accelerator device ASIC. As a guide, this interface should support at least 20 Mbits/sec. An interrupt to the Apps Processor may also be desirable to allow the accelerator device software to sleep in a power-efficient way.

Interface_{—}5 This is the accelerator device's software API and it represents a set of numerical methods and the memory transfers that they require between their functions (collision detection, solver, position update). These numerical methods are tailored to solve different physics problems (rigids, deformables, particles etc) supported by the accelerator device product. This interface may also have to work either with legacy physics engines or with different types of physics engines tailored to certain game physics specifics. It can also serve as a buffer against future evolutionary changes to either accelerator device or the engine algorithms during future product iterations.

Layer_{—}5 In general, the “one-stop game physics solution” mentioned in layer 2 may be modelled in several layers as described earlier. In order to accelerate the operation of the engine, the lower “calculation library” layer has to be implemented in hardware. Without direct in-system bus access this becomes inefficient due to the overhead of passing input parameters and output results to/from the hardware accelerator. Hence, ideally the physics problem to be solved for an island should fit at once (at each frame iteration) within the accelerator device so that the set of numerical methods to simulate that type of island physics for another frame accesses only local information.

Interface_{—}6 This is the lowest level accelerator device API and, unless some special set of matrix operation macros are to be provided, one can consider that this API level is subsumed mainly by the accelerator device vector processing unit instruction set. However, the main functionality provided here is for the manipulation of vectors and matrices such as dot-product calculations. These operations are used to implement the more complex numerical functions provided as “downloaded accelerator device firmware”.

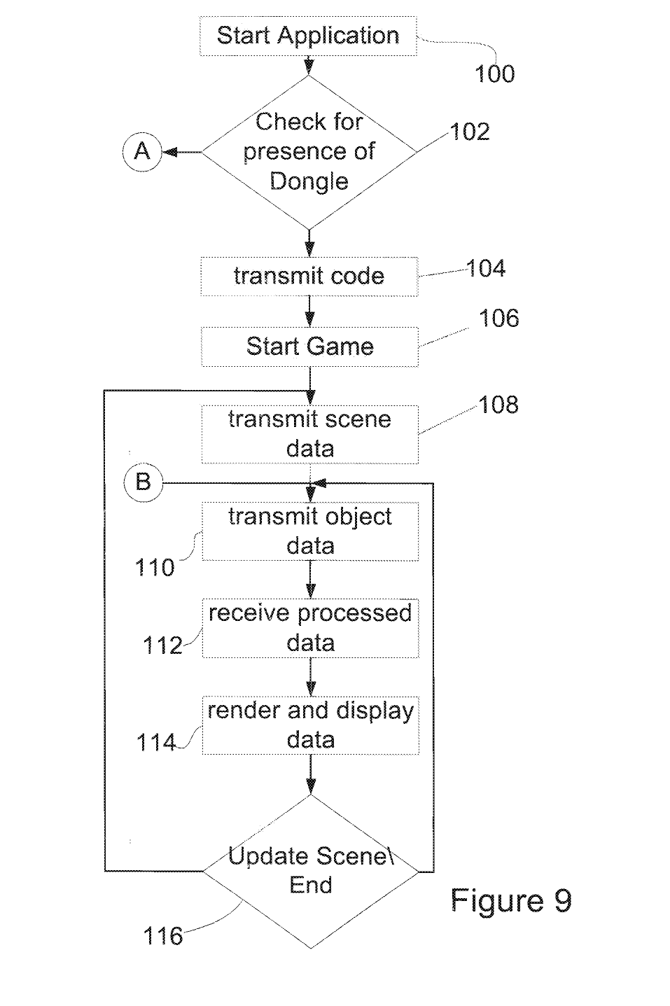

An exemplary mode of operation of an application will now be described with reference to the exemplary flow diagram of FIG. 9. The method commences 100 with a user starting a game on the wireless device using familiar techniques. The Application launches on the wireless device and checks 102 to determine whether the accelerator device is attached. In the event (A) that the wireless device is not present, the application may exit providing the user with an appropriate message, e.g. “accelerator device not attached check connection and re-try”. Alternatively, the application may revert to an alternative mode of operation employed when an accelerator device is not present, i.e. lower complexity characters and\or motion, a lower refresh rate, etc and use the applications processor in place of the accelerator device.

If the presence of accelerator device is detected, then the mobile device may transmit 104 program code for use in the acceleration process by the processor of the accelerator device. In some circumstances, the acceleration device may be pre-loaded with the required program code. As this is happening, a message may be displayed to the user on the display of the mobile device indicating, for example, that the game is being loaded.

Once the program code has been loaded, a message may be displayed allowing the user to start the game 106. Once the user has started the game, the mobile device may transmit 108 general scene information or other details to the accelerator device, this is information that does not change frame by frame but may only change every couple of seconds. Information about individual objects including their position, velocity, mass, orientation, etc are then transmitted 110. This information may be cached on the accelerator device. Caching the object information on the accelerator device and only updating object information for new or deleted objects in the scene reduces the bandwidth requirements between the mobile and accelerator devices. A complete update of the object data for all objects in the scene is only required intermittently if the entire scene is changed (for example, when changing levels in a game).

The accelerator device processes this data, which as explained previously may require a significant number of calculations and returns the result to the mobile device. The mobile device in turn renders 114 the received object data into a graphical representation for display on the screen of the device. As the game progresses, users may enter moves (B) as in a conventional game.

After graphics rendering and updating the display, a determination is made as to whether 116 the general scene information is to be updated. If not, updated object data for any new or deleted objects is transmitted to the accelerator device for processing. If a scene update is required, the information for all objects in the scene is updated.

This process continues until the game ends.

Although, the accelerator is primarily intended for use with wireless (cellular) phones, it will be appreciated that several types of mobile device could take advantage of the accelerator including Cellular Phones, Portable Gaming Consoles, Personal Media Players, Personal Navigation Devices, Personal Digital Assistants and Digital Cameras.

Similarly, although the accelerator is particularly intended for games physics processing employing one or more of the following artificial intelligence, linear algebra, geometric algebra, the accelerator may readily be adapted for other similar computational tasks including image processing, image recognition, graphics processing and\or search engines.

The words comprises/comprising when used in this specification are to specify the presence of stated features, integers, steps or components but does not preclude the presence or addition of one or more other features, integers, steps, components or groups thereof.

1. A system comprising a portable electronics device and an accelerator device,
the portable electronics device comprising:
a display,
a keypad or other device for accepting inputs from a user,
at least one applications processor,
at least one memory,
the applications processor and memory being configured to run software on the portable electronics device,
an interface for transmitting and receiving data from the applications processor, the interface having an associated socket
the accelerator device comprising:
a connector for engaging with the associated socket,
an interface associated with the connector for communicating with the interface of the portable electronics device and transferring data communicated between the portable electronics device and the accelerator device via the connector and socket,
at least one memory
at least one processor,
wherein the system further comprises a multi-layered application having a first layer stored in the at least one memory of the portable electronics device and run by the at least one applications processor,
a second layer being stored in the at least one memory of the accelerator device and run by the at least one processor of the accelerator device, wherein the first layer is configured to provide data to said second layer to perform calculations on and the second layer is configured to return the results of the calculations to the portable electronics device.

2. A system according to claim 1, wherein the interface between the accelerator device and the portable electronics device is a digital interface, optionally a serial interface.

3. A system according to claim 2, wherein the interface is a USB interface.

4. A system according to claim 1, wherein the interface between the accelerator device and the portable electronics device is a memory interface.

5. A system according to claim 1, wherein the interface between the accelerator device and the portable electronics device is a cartridge interface.

6. A system according to claim 1, wherein the accelerator device is provided as a dongle.

7. A system according to claim 6, wherein the dongle comprises a housing, the housing having a connector provided thereon for co-operating with a compatible connector on the portable electronics device.

8. A system according to claim 7, wherein the at least one processor of the accelerator device is provided as a integrated circuit die or packaged integrated circuit mounted on a printed circuit board and contained within the housing.

9. A system according to claim 7, wherein the dongle comprises a clock source.

10. A system according to claim 7 wherein the dongle comprises a power source.

11. A system according to claim 10, wherein the power source is rechargeable.

12. A system according to claim 7, wherein at least one memory device is provided within the dongle.

13. A system as in claim 7 wherein the dongle housing is in the form factor of a memory card.

14. A system as in claim 7 wherein the dongle housing is in the form factor of a USB Key.

15. A system as in claim 7 wherein the dongle housing is in the form factor of a cartridge.

16. A system according to claim 1, wherein the division between layers operating on the portable electronic device and the accelerator device is selected to minimise data transfer between the two devices.

17. A system according to claim 1, wherein the division between layers operating on the portable electronic device and the accelerator device is selected to minimise linear algebra calculations on the portable electronics device.

18. A system according to claim 1, wherein the accelerator device further comprises a cache and a local copy of the data is stored in a cache on the accelerator device in order to minimise the required data bandwidth between the portable electronics device and the accelerator device.

19. A system according to claim 18, wherein the portable electronics device is adapted to initially provide the accelerator device with the local copy.

20. A system according to claim 19, wherein the portable electronics device is adapted to provide updates to the local copy to the accelerator device when the copy of the data on the portable electronics device changes.

21. A system according to claim 1, wherein the accelerator device processor is configured to specifically perform matrix calculations.

22. A system according to claim 1, wherein the accelerator device processor and the applications processor are different types of processor.

23. A system according to claim 1, wherein the first layer performs further processing on the results of calculations returned by the second layer.

24. A method of operating a system comprising a portable electronics device having at least one processor and an acceleration device having at least one processor, the acceleration device being configured to assist the portable electronics device in the processing of data, the method comprising the steps of;
a) connecting the acceleration device to the portable electronics device,
b) transmitting data to the acceleration device for processing,
c) receiving processed data from the acceleration device.

25. A method according to claim 24, further comprising the step of determining the presence of the acceleration device.

26. A method according to claim 25, wherein the step of determining the presence of the acceleration device comprises the step of identifying the acceleration device.

27. A method according to claim 24, comprising the step of downloading program code to the acceleration device in response to the identification of the acceleration device.

28. A method according to claim 24, comprising the step of initially downloading general information about subsequent data to be processed.

29. A method according to claim 24, wherein the time for transmission and reception of data is relatively short, suitably less than 20% and preferably less than 10%, compared to the time required for the transmitted data to be processed by the processor of the portable electronic device.

30. A portable electronics system comprising: a mobile device and a dongle separable from but operably coupled to the mobile device, wherein the dongle is configured to enable, accelerate or improve the execution of an application running on the mobile device by performing calculations on data provided by the mobile device where the overhead for transferring data between the mobile device and the dongle to perform the calculations is relatively low, suitably less than 20% and preferably less than 10%, compared to the overhead required if the mobile device was to perform the calculations.

31. A portable electronics system according to claim 30, wherein the electronic system is configured to provided matrix data and the dongle is configured to perform calculations upon said matrix data.

32. A portable electronics system according to claim 30, where the application running comprises one or more of the following elements: games physics, artificial intelligence processing, linear algebra processing, geometric algebra processing, image processing, image recognition, graphics processing or a search engine.

33. A system as in claim 30 wherein the mobile device and dongle are operably coupled via a digital interface.

34. A system as in claim 33 wherein the digital interface is a USB interface.

35. A system as in claim 33 wherein the digital interface is a memory card interface.

36. A system as in claim 33 wherein the digital interface is a cartridge interface.

37. A system as in claim 33 wherein the digital interface is a proprietary expansion interface.

38. A system as in claim 30 wherein the mobile device is a radio telephone.

39. A system as in claim 30 wherein the dongle comprises at least the following components; a housing, a connector compatibly formed for mating with a compatible connector on the mobile device, and at least one integrated circuit die or packaged integrated circuit mounted on a printed circuit board and contained within the housing.

40. A system as in claim 39 wherein the dongle also includes a clock source.

41. A system as in claim 39 wherein the dongle also includes a power source.

42. A system as in claim 39 wherein the dongle also includes one or more memory integrated circuits.

43. A system as in claim 39 wherein the housing is in the form factor of a memory card.

44. A system as in claim 39 wherein the housing is in the form factor of a USB Key.

45. A system as in claim 39 wherein the housing is in the form factor of a cartridge.

46. A method for enabling, accelerating or improving the running of an application on a mobile device comprising at least the steps of: detecting when a dongle is operably coupled to the mobile device, and using processing resources within the dongle to enable, accelerate or improve the running of the application on the mobile device.

47. A method according to claim 46, further comprising the step of displaying a warning message to the user in the event that a dongle is not detected.

48. A method according to claim 46, further comprising the step of defaulting to an alternative mode of operation in the event that a dongle is not detected.

49. A method for enabling, accelerating or improving the running of an application on a mobile device comprising the steps of: detecting when a dongle is operably coupled to the mobile device, and upon detecting the presence of the dongle diverting data processing from the mobile device to the dongle.

50. A method according to claim 49, wherein the data processing diverted has a high computational load relative to the bandwidth required to transfer the data to be processed between the mobile device and the dongle.

51. An accelerator device for attaching to a portable electronics device having an interface, the accelerator device comprising:
an interface for connecting to the interface of the portable electronics device and for accepting raw data for processing communicated from the portable electronics device,
a processor for processing the communicated raw data into processed data and being configured to return the processed data to the portable electronics device, wherein the processor of the accelerator device is of a different type to the processor of the portable electronics device.
